(19) United States
(12) Patent Application Publication
(10) Pub. No.: US 2026/0180209 A1
(43) Pub. Date: Jun. 25, 2026

(54) ELECTRICAL CONNECTION UNIT

(71) Applicant: Yazaki Corporation, Tokyo (JP)

(72) Inventor: Hirotaka MUKASA, Kakegawa-shi (JP)

(73) Assignee: Yazaki Corporation, Tokyo (JP)

(21) Appl. No.: 19/416,478

(22) Filed: Dec. 11, 2025

(30) Foreign Application Priority Data
Dec. 25, 2024 (JP) 2024-228440

(51) Int. Cl. H01R 4/34; H02G 3/16

(52) U.S. Cl. CPC H01R 4/34; H02G 3/16

(57) ABSTRACT

An electrical connection unit according to an embodiment includes: an electronic component having a terminal; a bus bar electrically connected to the terminal; a metal component that is disposed between the terminal and the bus bar, is in contact with the terminal, and is electrically connected to both the terminal and the bus bar; and a temperature detector that is accommodated in a hole portion provided in the metal component and is capable of detecting a temperature of the metal component.

### BACKGROUND OF THE INVENTION

### Field of the Invention

Embodiments of the present invention relate to an electrical connection unit.

Priority is claimed on Japanese Patent Application No. 2024-228440 filed in Japan on Dec. 25, 2024, the content of which is incorporated herein by reference.

### Description of Related Art

As one of in-vehicle devices, an electrical connection unit including an electronic component and a bus bar connected to the electronic component is used.

### PRIOR ART DOCUMENT

### Patent Document

Patent Document 1: PCT International Publication No. WO2021/059767

### SUMMARY OF THE INVENTION

With the increase in current of the electrical connection unit, it is desired to easily measure the temperature of the terminal of the electronic component.

An embodiment provides an electrical connection unit capable of easily measuring a terminal temperature of an electronic component.

An electrical connection unit according to an embodiment includes: an electronic component having a terminal; a bus bar electrically connected to the terminal; a metal component that is disposed between the terminal and the bus bar, is in contact with the terminal, and is electrically connected to both the terminal and the bus bar; and a temperature detector that is accommodated in a hole portion provided in the metal component and is capable of detecting a temperature of the metal component.

According to one embodiment, a terminal temperature of an electronic component can be easily measured.

### BRIEF DESCRIPTION OF THE DRAWINGS

FIG. 1 is a cross-sectional view illustrating an electrical connection unit 1 according to a first embodiment.

FIG. 2 is a perspective view illustrating a part of the electrical connection unit 1.

FIG. 3 is an exploded perspective view of a part of the electrical connection unit 1.

FIG. 4 is a plan view illustrating a first electronic component and a metal component.

FIG. 5 is a cross-sectional view illustrating the first electronic component and the metal component.

FIG. 6 is a cross-sectional view for explaining the method of manufacturing the electrical connection unit 1.

FIG. 7 is a cross-sectional view for explaining the method of manufacturing the electrical connection unit 1.

FIG. 8 is a cross-sectional view for explaining the method of manufacturing the electrical connection unit 1.

FIG. 9 is a cross-sectional view illustrating a metal component of a second embodiment.

FIG. 10 is a cross-sectional view illustrating a metal component of a third embodiment.

FIG. 11 is a cross-sectional view illustrating a metal component of a fourth embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. “Parallel”, “orthogonal”, or “the same” may include “substantially parallel”, “substantially orthogonal”, or “substantially the same”, respectively.

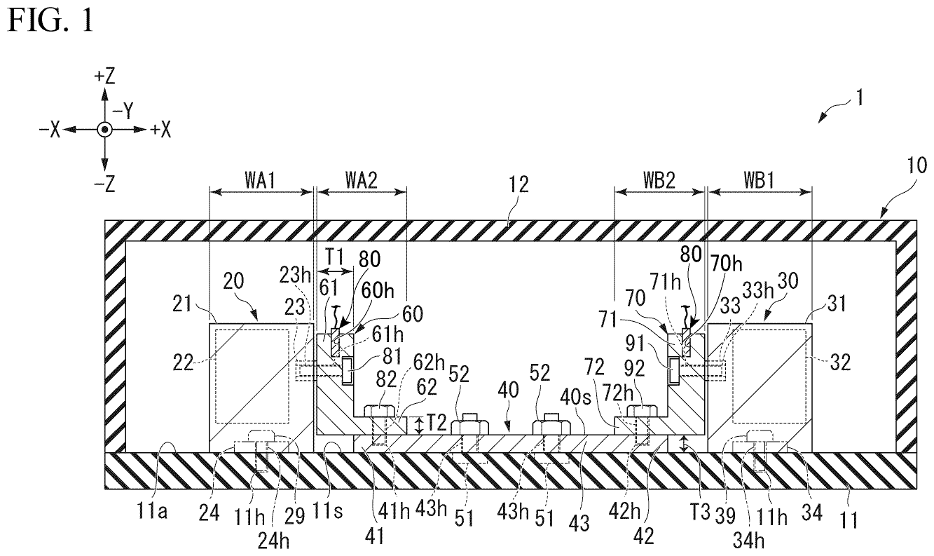

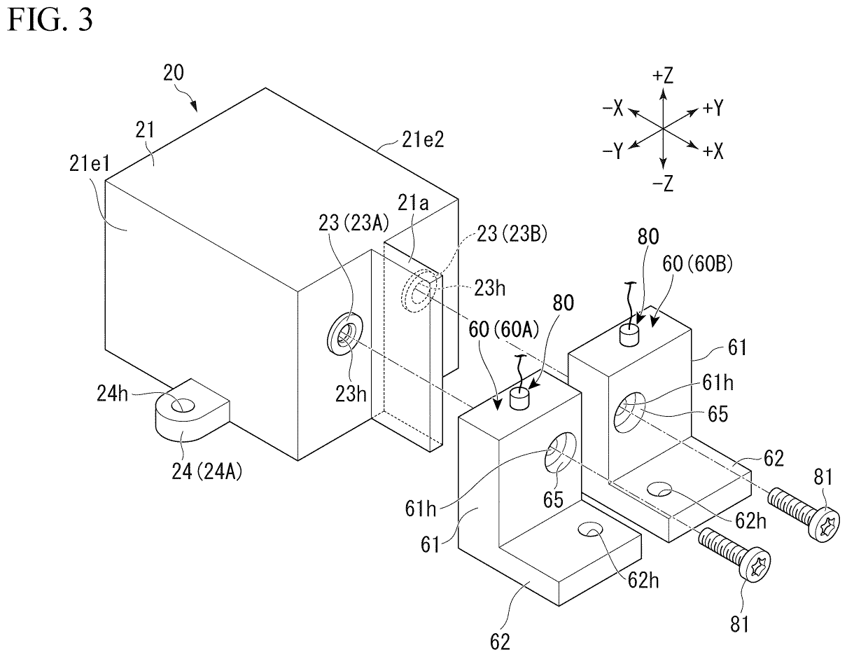

In the present disclosure, a +X direction, a −X direction, a +Y direction, a −Y direction, a +Z direction, and a −Z direction are defined as follows. The +X direction is a direction from a first electronic component 20 toward a first metal component 60 to be described later (see FIG. 1). The −X direction is a direction opposite to the +X direction. Hereinafter, the +X direction and the −X direction are simply referred to as an “X direction” when they are not distinguished from each other. The +Y direction is a direction from a first terminal portion 23A toward a second terminal portion 23B of the first electronic component 20 (see FIG. 3). The −Y direction is a direction opposite to the +Y direction. Hereinafter, the +Y direction and the −Y direction are simply referred to as a “Y direction” when they are not distinguished from each other. The +Z direction is a direction from a base member 11 toward a bus bar 40 to be described later (see FIG. 1). The −Z direction is a direction opposite to the +Z direction. Hereinafter, the +Z direction and the −Z direction are simply referred to as a “Z direction” when they are not distinguished from each other.

### First Embodiment

First, a first embodiment will be described. In the first embodiment, the Z direction is an example of a “first direction”. The X direction is an example of a “direction intersecting the first direction”.

### A1. Constitution of Electrical Connection Unit

FIG. 1 is a cross-sectional view illustrating an electrical connection unit 1 according to the first embodiment. The electrical connection unit 1 is used for a vehicle such as an electric vehicle (EV), a hybrid electric vehicle (HEV), or a plug-in hybrid electric vehicle (PHEV). The electrical connection unit 1 is, for example, a component called an electrical connection box or a junction box.

FIG. 1 is a cross-sectional view illustrating the electrical connection unit 1. The electrical connection unit 1 includes, for example, a housing 10, a plurality of electronic components 20 and 30, a plurality of bus bars 40 (only one is illustrated in FIG. 1), a plurality of metal components 60 and 70, and a temperature detector 80.

### A1.1 Housing

The housing 10 is an outer member that forms the outer shape of the electrical connection unit 1. The housing 10 accommodates the plurality of electronic components 20 and 30, the plurality of bus bars 40, and the plurality of metal components 60 and 70. The housing 10 includes, for example, a base member 11 and a cover member 12.

The base member 11 is, for example, a member that forms a bottom portion of the housing 10. The base member 11 is made of, for example, a synthetic resin and has an insulating property. The base member 11 has a support surface 11a exposed to the inside of the housing 10. At least a part of the support surface 11a has, for example, a plane 11s extending in the X direction and the Y direction.

A plurality of fastening members 51 (for example, screws) are fixed to the base member 11 of the present embodiment. The fastening member 51 is fixed to the base member 11 by being insert-molded into the base member 11. The head portion of the fastening member 51 is embedded in the base member 11. The shaft portion of the fastening member 51 protrudes in the +Z direction from the plane 11s of the base member 11 and extends in the +Z direction. The shaft portion of the fastening member 51 has a spiral screw thread. The fastening member 51 may be fixed to the base member 11 by means different from insert molding.

The cover member 12 is, for example, a member that forms a lid portion of the housing 10. In the present embodiment, the housing 10 is formed by combining the base member 11 and the cover member 12. The cover member 12 is made of, for example, a synthetic resin and has an insulating property. The bus bar 40 may be fixed to the cover member 12 instead of the base member 11.

### A1.2 Electronic Component

The plurality of electronic components 20 and 30 are electronic components mounted according to functions or applications required for the electrical connection unit 1. Each of the electronic components 20 and 30 is, for example, a connector, a fuse, a relay (for example, a mechanical relay or a semiconductor relay), a capacitor, a branch component, an electronic control unit, or an electronic component unit in which two or more of these are unitized. Note that the types of the electronic components 20 and 30 are not limited to the above examples. The electronic component 20 and the electronic component 30 may be the same type of components or different types of components. The electronic components 20 and 30 are, for example, heat generating components that generate heat at the time of energization.

Hereinafter, for convenience of description, the electronic component 20 may be referred to as a “first electronic component 20”. Further, the electronic component 30 may be referred to as a “second electronic component 30”. Note that the electrical connection unit 1 may include only one electronic component (for example, only one of the electronic components 20 and 30) instead of including the plurality of electronic components 20 and 30.

### A1.2.1 First Electronic Component

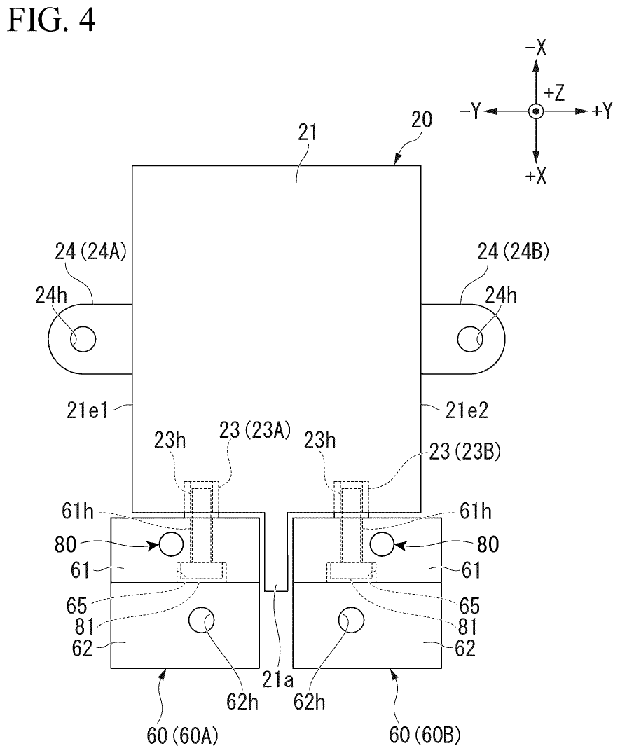

The first electronic component 20 includes, for example, a case 21, a body portion 22, a plurality of terminal portions 23 (see FIG. 3), and a plurality of attachment portions 24 (see FIG. 4).

### (Case)

The case 21 is an outer member that forms most of the outer shape of the first electronic component 20. The case 21 is made of, for example, a synthetic resin and has an insulating property. The case 21 accommodates the body portion 22. The case 21 and the body portion 22 may be integrally formed.

### (Body Portion)

The body portion 22 is a portion that performs a main function of the first electronic component 20. For example, in a case where the first electronic component 20 is a relay, the body portion 22 includes a switch (for example, a contact) that switches between a conductive state and a non-conductive state. For example, in a case where the first electronic component 20 is a fuse, the body portion 22 includes a fusion portion that melts when an overcurrent flows. For example, in a case where the first electronic component 20 is a capacitor, the body portion 22 includes a portion that stores electric charge.

### (Terminal Portion)

The terminal portion 23 is an electrical connection portion exposed to the outside of the case 21. The terminal portion 23 is electrically connected to the body portion 22 inside the case 21. In the present embodiment, the first electronic component 20 includes a first terminal portion 23A and a second terminal portion 23B as the plurality of terminal portions 23 (see FIG. 3). The first terminal portion 23A and the second terminal portion 23B are disposed at positions away from the support surface 11a of the base member 11 in the +Z direction.

In the present embodiment, the first terminal portion 23A and the second terminal portion 23B are provided at end portions on the +X direction side of the first electronic component 20. The first terminal portion 23A and the second terminal portion 23B are arranged side by side in the Y direction (see FIG. 3). Hereinafter, when the first terminal portion 23A and the second terminal portion 23B are not distinguished, they are simply referred to as “terminal portions 23”. The terminal portion 23 has an attachment hole 23h to which a first fastening member 81 (for example, a screw) described later is attached. The attachment hole 23h is opened in the X direction. For example, the attachment hole 23h has a screw groove on the inner peripheral surface.

### (Attachment Portion)

The attachment portion 24 is a portion for fixing the first electronic component 20. For example, the attachment portion 24 is a portion for fixing the first electronic component 20 to the base member 11. In the present embodiment, the first electronic component 20 includes, as the plurality of attachment portions 24, a first attachment portion 24A and a second attachment portion 24B (see FIG. 4). The first attachment portion 24A and the second attachment portion 24B are separately disposed on both sides of the case 21 in the Y direction. For example, the first attachment portion 24A protrudes from the case 21 in the −Y direction. The second attachment portion 24B protrudes from the case 21 in the +Y direction.

Hereinafter, when the first attachment portion 24A and the second attachment portion 24B are not distinguished from each other, they are simply referred to as “attachment portions 24”. The attachment portion 24 has an attachment hole 24h to which the fastening member 29 (for example, a screw) is attached. The attachment hole 24h is opened in the Z direction. The attachment hole 24h is an insertion hole through which the fastening member 29 passes. In the present embodiment, the base member 11 has an attachment hole 11h at a position corresponding to the attachment hole 24h. The attachment hole 11h is opened in the Z direction. For example, the attachment hole 11h has a screw groove on the inner peripheral surface. In the present embodiment, the fastening member 29 passed through the attachment hole 24h of the attachment portion 24 is engaged with the attachment hole 11h, whereby the first electronic component 20 is fixed to the base member 11. The attachment hole 11h may be an attachment hole directly provided in the base member 11, or may be an attachment hole of an engagement member (for example, a nut) embedded in the base member 11 by, for example, insert molding or other means.

### A1.2.2 Second Electronic Component

The second electronic component 30 includes, for example, a case 31, a body portion 32, a plurality of terminal portions 33, and a plurality of attachment portions 34. Details of the second electronic component 30 are, for example, similar to those of the first electronic component 20. Therefore, in the description regarding the second electronic component 30, “first electronic component 20”, “case 21”, “body portion 22”, “terminal portion 23”, “attachment hole 23h”, “attachment portion 24”, “attachment hole 24h”, “fastening member 29”, and “+X direction” in the description regarding the first electronic component 20 described above may be replaced with “second electronic component 30”, “case 31”, “body portion 32”, “terminal portion 33”, “attachment hole 33h”, “attachment portion 34”, “attachment hole 34h”, “fastening member 39”, and “−X direction”, respectively.

### A1.3 Bus Bar

The bus bar 40 is a wiring member included in the electrical connection unit 1. The bus bar 40 is, for example, a wiring member for electrically connecting the plurality of electronic components. Alternatively, the bus bar 40 may be a wiring member that connects one electronic component and the outside of the electrical connection unit 1.

The bus bar 40 is at least partially plate-shaped. In the present embodiment, the bus bar 40 has a plate shape over the entire bus bar 40. The bus bar 40 is disposed along the base member 11. The bus bar 40 has a planar plate surface 40s. The plate surface 40s of the bus bar 40 is parallel to the plane 11s of the base member 11 over the entire length of the bus bar 40. The bus bar 40 is fixed to the base member 11, for example. The bus bar 40 has a plate thickness T3. The plate thickness T3 is a thickness of the bus bar 40 in the Z direction.

Here, an example of the bus bar 40 will be described in detail by taking up the bus bar 40 that electrically connects the first electronic component 20 and the second electronic component 30. The bus bar 40 includes, for example, a first connection portion 41, a second connection portion 42, and an extension portion 43. In the present embodiment, each of the first connection portion 41, the second connection portion 42, and the extension portion 43 has a plate shape along the X direction and the Y direction.

### (First Connection Portion)

The first connection portion 41 is a portion electrically connected to the first electronic component 20. The first connection portion 41 is provided at one end portion of the bus bar 40. The first connection portion 41 has an attachment hole 41h through which the second fastening member 82 (for example, a screw) passes. The attachment hole 41h is opened in the Z direction. In the present embodiment, the first connection portion 41 is disposed away from the terminal portion 23 of the first electronic component 20. For example, the first connection portion 41 is disposed along the base member 11.

### (Second Connection Portion)

The second connection portion 42 is a portion electrically connected to the second electronic component 30. The second connection portion 42 is provided at the other end portion of the bus bar 40. The second connection portion 42 has an attachment hole 42h through which the fastening member 92 (for example, a screw) passes. The attachment hole 42h is opened in the Z direction. In the present embodiment, the second connection portion 42 is disposed away from the terminal portion 33 of the second electronic component 30. For example, the second connection portion 42 is disposed along the base member 11.

### (Extension Portion)

The extension portion 43 is provided between the first connection portion 41 and the second connection portion 42. The extension portion 43 extends, for example, in the X direction along the base member 11, and connects the first connection portion 41 and the second connection portion 42. In the present embodiment, the extension portion 43 has an attachment hole 43h through which the fastening member 51 passes. The bus bar 40 is placed on the plane 11s of the base member 11 in a state where the shaft portion of the fastening member 51 passes through the attachment hole 43h. In a state where the shaft portion of the fastening member 51 passes through the attachment hole 43h, the engagement member 52 (for example, a nut) is attached to the shaft portion of the fastening member 51 from the +Z direction side, whereby the bus bar 40 is fixed to the base member 11.

### A1.4 Metal Component

The metal component 60 is disposed between the first connection portion 41 and the terminal portion 23. The metal component 60 is in contact with the terminal portion 23. The metal component 60 is electrically connected to both the terminal portion 23 and the bus bar 40. Similarly, the metal component 70 is disposed between the second connection portion 42 and the terminal portion 33. The metal component 70 is in contact with the terminal portion 33. The metal component 70 is electrically connected to both the terminal portion 33 and the bus bar 40. The metal component 60 is made of a metal (for example, made of copper, a copper alloy, aluminum, or an aluminum alloy).

The metal components 60 and 70 of the present embodiment are heat storage members that increase the heat capacity of the conduction path of the electrical connection unit 1. The metal components 60 and 70 store (absorb) at least a part of heat generated by the electronic components 20 and 30, for example. The plurality of metal components 60 and 70 may store (absorb) at least a part of heat generated by the bus bar 40 by energization. Each of the metal components 60 and 70 may be referred to as a “heat storage component” or a “heat absorbing component”.

In the present embodiment, the metal component 60 has a hole portion 60h that accommodates the temperature detector 80. The metal component 70 has a hole portion 70h that accommodates the temperature detector 80.

Hereinafter, for convenience of description, the metal component 60 may be referred to as a “first metal component 60”. In addition, the metal component 70 may be referred to as a “second metal component 70”. Note that the electrical connection unit 1 may include only one metal component (for example, only one of the metal components 60 and 70) instead of including the plurality of metal components 60 and 70.

### A1.4.1 First Metal Component

The first metal component 60 is disposed between the first electronic component 20 and the bus bar 40. In the present disclosure, the phrase “the metal component is disposed between the electronic component and the bus bar” is not limited to a case where a part of the metal component is located between the electronic component and the bus bar when viewed from the X direction or the Y direction. The phrase “the metal component is disposed between the electronic component and the bus bar” may correspond to a case where a part of the metal component is located between the electronic component and the bus bar when viewed from a direction inclined with respect to the X direction or the Y direction.

The first metal component 60 electrically connects the terminal portion 23 of the first electronic component 20 and the first connection portion 41 of the bus bar 40. The first metal component 60 includes, for example, a first portion 61 and a second portion 62.

### (First Portion)

The first portion 61 is a portion connected to the terminal portion 23 of the first electronic component 20. The first portion 61 is a relatively thick plate portion extending in the Y direction and the Z direction. The first portion 61 extends in the Z direction along an end portion on the +X direction side of the first electronic component 20. The first portion 61 is in a posture standing with respect to the support surface 11a (for example, the plane 11s) of the base member 11.

The first portion 61 is adjacent to the first electronic component 20 in the X direction. For example, the first portion 61 is adjacent to at least a part of the body portion 22 of the first electronic component 20 in the X direction. The first portion 61 faces the terminal portion 23 of the first electronic component 20 from the +X direction side. The first portion 61 is connected to the terminal portion 23 of the first electronic component 20 from the X direction.

In the present embodiment, the first portion 61 has a first attachment hole 61h through which the first fastening member 81 (for example, a screw) passes. The first attachment hole 61h is opened in the X direction. The first portion 61 has a recess 65 on the +X direction side of the first attachment hole 61h. The recess 65 is an accommodation portion that accommodates a head portion of the first fastening member 81 inserted into the first attachment hole 61h. The first portion 61 is physically and electrically connected to the terminal portion 23 of the first electronic component 20 by engagement of the first fastening member 81 passed through the first attachment hole 61h with the attachment hole 23h of the terminal portion 23 of the first electronic component 20.

In the present embodiment, the first portion 61 has a hole portion 60h capable of accommodating the temperature detector 80. The hole portion 60h has an opening on the surface of the first portion 61 facing the +Z direction. The hole portion 60h is recessed in the −Z direction from the surface of the first portion 61 facing the +Z direction. In the present embodiment, the hole portion 60h forms a columnar space extending in the Z direction.

### (Second Portion)

The second portion 62 is a portion connected to the first connection portion 41 of the bus bar 40. The second portion 62 protrudes in the +X direction from an end portion of the first portion 61 on the −Z direction side. The second portion 62 is a plate portion extending in the X direction and the Y direction. The second portion 62 extends in the X direction along the first connection portion 41 of the bus bar 40. In the present embodiment, the first portion 61 and the second portion 62 form one L-shaped piece of the first metal component 60.

The second portion 62 is adjacent to the first connection portion 41 of the bus bar 40 in the Z direction. The first portion 61 faces the first connection portion 41 of the bus bar 40 from the +Z direction side. The second portion 62 is connected to the first connection portion 41 of the bus bar 40 from the Z direction.

In the present embodiment, the second portion 62 has a second attachment hole 62h through which the second fastening member 82 (for example, a screw) passes. The second attachment hole 62h is opened in the Z direction. The second portion 62 is physically and electrically connected to the first connection portion 41 of the bus bar 40 by engagement of the second fastening member 82 passed through the second attachment hole 62h with the attachment hole 41h of the first connection portion 41 of the bus bar 40.

### (Shape of First Metal Component)

In the present embodiment, a thickness of at least a part of the first metal component 60 is larger than a plate thickness T3 of the bus bar 40. For example, a thickness T1 of at least a part of the first metal component 60 in the X direction is larger than the plate thickness T3 of the bus bar 40. In the present embodiment, the thickness T1 of the first portion 61 of the first metal component 60 in the X direction is larger than the plate thickness T3 of the bus bar 40. In the present embodiment, the first portion 61 has a thickness T1 larger than the plate thickness T3 of the bus bar 40 as a thickness in the X direction over the entire width of the first portion 61 in the Z direction. From another viewpoint, a thickness T2 of the second portion 62 of the first metal component 60 in the Z direction may be larger than the plate thickness T3 of the bus bar 40.

In the present embodiment, the thickness T1 of the first portion 61 of the first metal component 60 in the X direction is larger than the thickness T2 of the second portion 62 of the first metal component 60 in the Z direction. In the present embodiment, the first portion 61 has the thickness T1 larger than the thickness T2 of the second portion 62 over the entire width of the first portion 61 in the Z direction.

In the present embodiment, the longitudinal direction of the first electronic component 20 is the X direction. The width WA2 of the first metal component 60 in the X direction is, for example, smaller than the width WA1 of the first electronic component 20 in the X direction. When the longitudinal direction of the first electronic component 20 is the Y direction, the width of the first metal component 60 in the Y direction is smaller than the width of the first electronic component 20 in the Y direction, for example.

The first metal component 60 has a larger heat capacity per unit length than the bus bar 40. Due to the magnitude of the heat capacity, even when a short-term large current flows through the first electronic component 20 and the first electronic component 20 generates heat, a part of the heat generated by the first electronic component 20 is stored by the metal component 60. Therefore, a temperature change inside the electrical connection unit 1 can be suppressed.

### (Arrangement Example of First Metal Component)

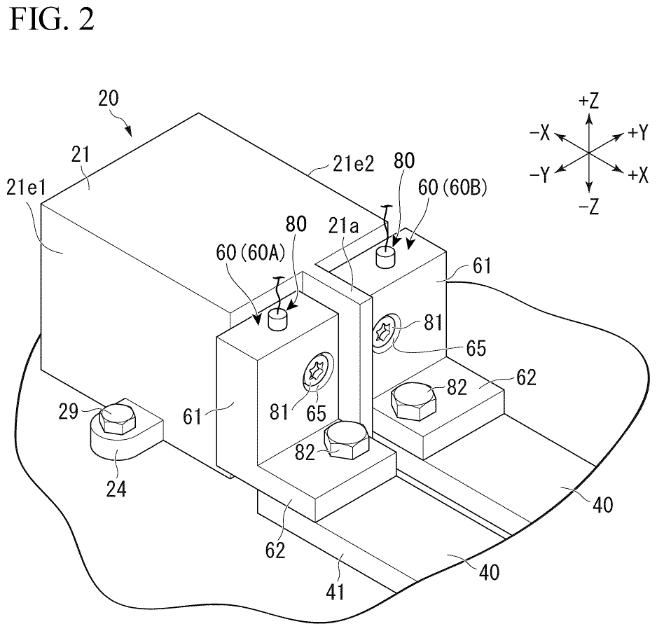

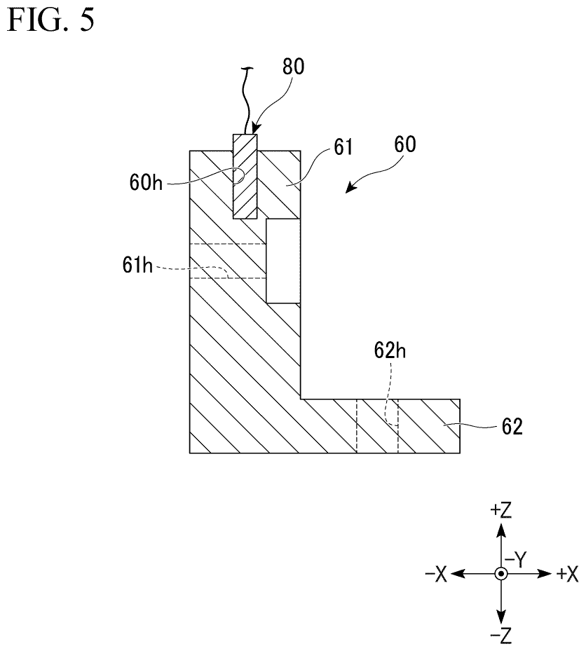

FIG. 2 is a perspective view illustrating a part of the electrical connection unit 1. FIG. 3 is an exploded perspective view of a part of the electrical connection unit 1. FIG. 4 is a plan view illustrating the first electronic component 20 and the metal components 60A and 60B. FIG. 5 is a cross-sectional view illustrating a metal component and a temperature detector. In the present embodiment, the electrical connection unit 1 includes a metal component 60A and a metal component 60B as the plurality of first metal components 60. The metal component 60A and the metal component 60B have, for example, symmetrical shapes in the Y direction.

The metal component 60A is disposed corresponding to a half portion of the first electronic component 20 on the −Y direction side. The metal component 60A is adjacent to the terminal portion 23A of the first electronic component 20 in the X direction, and is connected to the terminal portion 23A of the first electronic component 20 in the X direction. On the other hand, the metal component 60B is disposed corresponding to a half portion of the first electronic component 20 on the +Y direction side. The metal component 60B is adjacent to the terminal portion 23B of the first electronic component 20 in the X direction, and is connected to the terminal portion 23B of the first electronic component 20 in the X direction.

In the present embodiment, the case 21 has an insulating wall 21a protruding in the +X direction (see FIG. 2). The insulating wall 21a is provided at the center of the case 21 in the Y direction. The insulating wall 21a extends in the X direction and the Z direction. For example, the insulating wall 21a extends over the entire height of the case 21 in the Z direction. The insulating wall 21a is disposed between the first terminal portion 23A and the second terminal portion 23B. The insulating wall 21a electrically insulates the first terminal portion 23A from the second terminal portion 23B. In the present embodiment, the insulating wall 21a is disposed between the first portion 61 of the metal component 60A and the first portion 61 of the metal component 60B. The insulating wall 21a electrically insulates the first portion 61 of the metal component 60A from the first portion 61 of the metal component 60B.

In the present embodiment, the case 21 of the first electronic component 20 has an end 21e1 in the −Y direction and an end 21e2 in the +Y direction (see FIG. 4).

A part of the metal component 60A protrudes toward the −Y direction side from the end 21e1 of the case 21 of the first electronic component 20. A part of the metal component 60A protrudes to a region not overlapping the first electronic component 20 when viewed in the X direction. This protrusion increases the heat capacity of the metal component 60A.

Similarly, a part of the metal component 60B protrudes toward the +Y direction side from the end 21e2 of the case 21 of the first electronic component 20. A part of the metal component 60B protrudes to a region not overlapping the first electronic component 20 when viewed in the X direction. This protrusion increases the heat capacity of the metal component 60B.

### A1.4.2 Second Metal Component

Next, referring back to FIG. 1, the second metal component 70 will be described. The second metal component 70 is disposed between the second electronic component 30 and the bus bar 40. The second metal component 70 electrically connects the terminal portion 33 of the second electronic component 30 and the second connection portion 42 of the bus bar 40. The second metal component 70 includes, for example, a first portion 71 and a second portion 72.

Details of the second metal component 70 are, for example, similar to those of the first metal component 60. Therefore, in the description regarding the second metal component 70, “first portion 61”, “first attachment hole 61h”, “second portion 62”, “second attachment hole 62h”, “first electronic component 20”, “body portion 22”, “terminal portion 23”, “attachment hole 23h”, “first fastening member 81”, “second fastening member 82”, “first connection portion 41”, “attachment hole 41h”, “hole portion 60h”, and “+X direction” in the description regarding the first metal component 60 described above may be replaced with “first portion 71”, “first attachment hole 71h”, “second portion 72”, “second attachment hole 72h”, “second electronic component 30”, “body portion 32”, “terminal portion 33”, “attachment hole 33h”, “first fastening member 91”, “second fastening member 92”, “second connection portion 42”, “attachment hole 42h”, “hole portion 70h”, and “−X direction”, respectively.

In the present embodiment, the longitudinal direction of the second electronic component 30 is the X direction. The width WB2 of the second metal component 70 in the X direction is, for example, smaller than the width WB1 of the second electronic component 30 in the X direction. When the longitudinal direction of the second electronic component 30 is the Y direction, the width of the second metal component 70 in the Y direction is, for example, smaller than the width of the second electronic component 30 in the Y direction.

### A1.5 Temperature Detector

The temperature detector 80 is accommodated in each of the hole portions 60h and 70h provided in the metal components 60 and 70. In the present embodiment, the temperature detector 80 is accommodated in the hole portions 60h and 70h, and is fixed to the metal components 60 and 70 by, for example, a thermally conductive adhesive. The temperature detector 80 can detect the temperatures of the metal components 60 and 70. The temperature detector 80 outputs a temperature detection result as an electric signal. The detection result of the temperature detector 80 can be input to a control device that performs temperature monitoring, or can be displayed on an external display. As the temperature detector 80, for example, a thermistor can be used. In the present embodiment, the temperature detector 80 has an elongated columnar shape such as a column or a prism, and an electric wire for output is connected to an end portion in the longitudinal direction thereof.

The temperature detector 80 detects the temperatures of the metal components 60 and 70. On the other hand, the metal components 60 and 70 are in direct contact with the terminal portions 23 and 33, and are indirectly connected to the terminal portions 23 and 33 via the fastening member 81 made of metal. That is, heat can be transferred between the metal components 60 and 70 and the terminal portions 23 and 33. The temperature detector 80 indirectly detects the temperatures of the terminal portions 23 and 33 by detecting the temperatures of the metal components 60 and 70.

### A2. Method of Manufacturing Electrical Connection Unit

Next, a method of manufacturing the electrical connection unit 1 will be described.

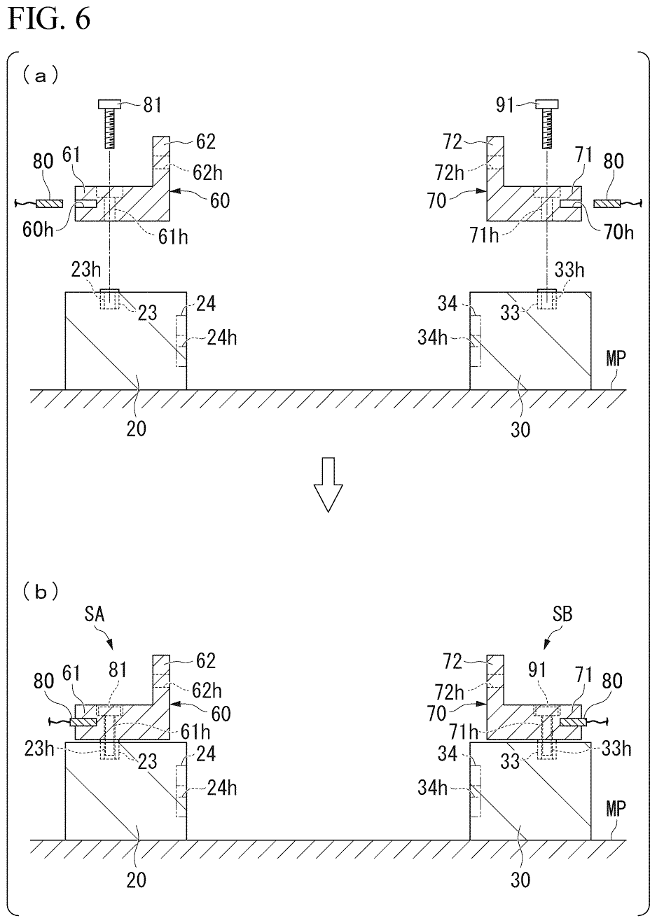

FIGS. 6 to 8 are cross-sectional views for describing the method of manufacturing the electrical connection unit 1.

### (First Step)

FIG. 6 illustrates a first step and a second step. In the first step, the temperature detector 80 is inserted into the hole portion 60h of the first metal component 60 and the hole portion 70h of the second metal component 70, and the temperature detector 80 is fixed in the hole portions 60h and 70h using a thermally conductive adhesive or the like. By this fixing, the first metal component 60 and the temperature detector 80 are integrated. Similarly, the second metal component 70 and the temperature detector 80 are integrated.

### (Second Step)

In the second step, the first metal component 60 is fixed to the terminal portion 23 of the first electronic component 20 using the fastening member 81. By this fixing, a first assembly SA in which the first electronic component 20 and the first metal component 60 are integrated is formed.

The second step is performed, for example, as follows. First, the first electronic component 20 is placed on a placement table MP in a posture in which the attachment hole 23h of the terminal portion 23 of the first electronic component 20 is directed in the vertical direction. Next, the first metal component 60 is placed on the first electronic component 20 in a posture in which the first attachment hole 61h of the first metal component 60 is directed in the vertical direction. The first attachment hole 61h of the first metal component 60 and the attachment hole 23h of the terminal portion 23 of the first electronic component 20 are aligned. The first step is performed in a state where the first electronic component 20 and the first metal component 60 are in the first posture. The first posture is a posture in which the attachment hole 23h and the first attachment hole 61h are directed in the vertical direction.

Next, the fastening member 81 is inserted into the first attachment hole 61h of the first metal component 60 from the vertical direction. The fastening member 81 passed through the first attachment hole 61h of the first metal component 60 is engaged with the attachment hole 23h of the terminal portion 23 of the first electronic component 20. By this engagement, the first assembly SA in which the first electronic component 20 and the first metal component 60 are integrated is formed. The vertical direction is an example of a “first attachment direction”.

Similarly, the second metal component 70 is fixed to the terminal portion 33 of the second electronic component 30 using the fastening member 91. By this fixing, a second assembly SB in which the second electronic component 30 and the second metal component 70 are integrated is formed.

### (Third Step)

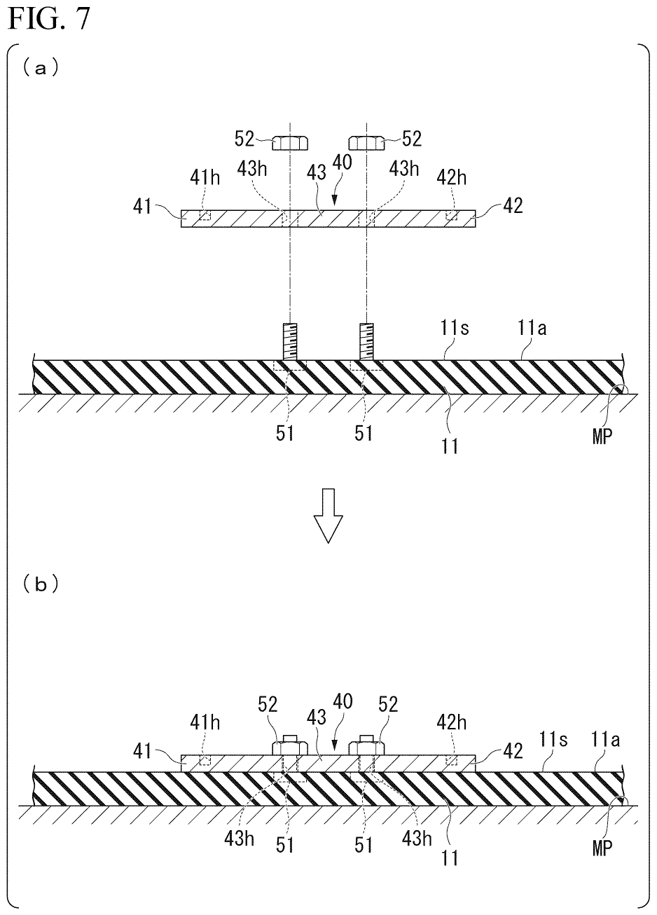

FIG. 7 illustrates a third step. In the third step, the bus bar 40 is fixed to the base member 11. This step may be performed before the second step, after the second step, or in parallel with the second step.

The third step is performed, for example, as follows. As described above, the fastening member 51 is previously fixed to the base member 11, for example. The fastening member 51 protrudes along the vertical direction. The bus bar 40 is placed on the base member 11 such that the fastening member 51 is inserted into the attachment hole 43h of the bus bar 40 along the vertical direction. Next, the engagement member 52 (for example, a nut) is engaged with the upper end portion of the fastening member 51 from the vertical direction. By this engagement, the bus bar 40 is fixed to the base member 11. In the present embodiment, the bus bar 40 is fixed to the base member 11 before fixing the electronic components 20 and 30 to the base member 11.

### (Fourth Step)

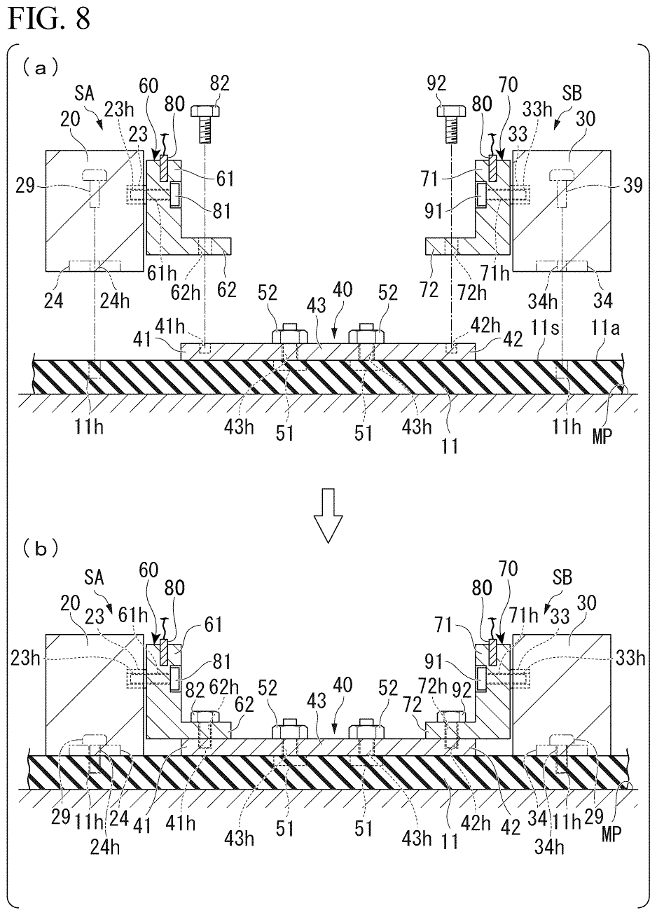

FIG. 8 illustrates a fourth step. The fourth step is performed after the second step and the third step. In the fourth step, the first assembly SA is fixed to the first connection portion 41 of the bus bar 40 using the second fastening member 82. For example, the first metal component 60 included in the first assembly SA is fixed to the first connection portion 41 of the bus bar 40 using the second fastening member 82. By this fixing, the first electronic component 20 and the bus bar 40 are electrically connected.

The fourth step is performed, for example, as follows. First, the posture of the first assembly SA is rotated by 90 degrees from the first step. That is, the first posture (see FIG. 6) in which the attachment hole 23h and the first attachment hole 61h are directed in the vertical direction is changed to the second posture (see FIG. 8) in which the attachment hole 23h and the first attachment hole 61h are directed in the horizontal direction and the second attachment hole 62h of the first metal component 60 is directed in the vertical direction.

In the second posture, the second portion 62 of the first metal component 60 is placed on the first connection portion 41 of the bus bar 40. The second attachment hole 62h of the first metal component 60 and the attachment hole 41h of the first connection portion 41 of the bus bar 40 are aligned.

Next, the second fastening member 82 is inserted into the second attachment hole 62h of the first metal component 60 from the vertical direction. The second fastening member 82 passed through the second attachment hole 62h of the first metal component 60 is engaged with the attachment hole 41h of the first connection portion 41 of the bus bar 40. By this engagement, the first metal component 60 is fixed to the first connection portion 41 of the bus bar 40. That is, the first assembly SA is fixed to the first connection portion 41 of the bus bar 40. By this fixing, the first electronic component 20 and the first connection portion 41 of the bus bar 40 are electrically connected. In the present embodiment, the direction in which the bus bar 40 is fixed to the base member 11 coincides with the direction in which the first assembly SA is fixed to the bus bar 40.

In the fourth step, the attachment portion 24 of the first electronic component 20 may be fixed to the base member 11 using the fastening member 29. This work is performed as follows, for example. First, the attachment hole 24h of the attachment portion 24 of the first electronic component 20 and the attachment hole 11h of the base member 11 are aligned. Next, the fastening member 29 is inserted into the attachment hole 24h of the first electronic component 20 from the vertical direction. The fastening member 29 passed through the attachment hole 24h of the first electronic component 20 is engaged with the attachment hole 11h of the base member 11. By this engagement, the first electronic component 20 is fixed to the base member 11. The work of fixing the first electronic component 20 to the base member 11 using the fastening member 29 may be performed before or after the work of fixing the first metal component 60 to the bus bar 40 using the second fastening member 82. In the present embodiment, a direction in which the bus bar 40 is fixed to the base member 11, a direction in which the first assembly SA is fixed to the bus bar 40, and a direction in which the first electronic component 20 is fixed to the base member 11 coincide with each other.

Similarly, the posture of the second assembly SB is rotated by 90 degrees from the first step. That is, the first posture (see FIG. 6) in which the attachment hole 33h and the first attachment hole 71h are directed in the vertical direction is changed to the second posture (see FIG. 8) in which the attachment hole 33h and the first attachment hole 71h are directed in the horizontal direction and the second attachment hole 72h of the second metal component 70 is directed in the vertical direction.

In the second posture, the second portion 72 of the second metal component 70 is placed on the second connection portion 42 of the bus bar 40. The second attachment hole 72h of the second metal component 70 and the attachment hole 42h of the second connection portion 42 of the bus bar 40 are aligned.

Next, the second fastening member 92 is inserted into the second attachment hole 72h of the second metal component 70 from the vertical direction. The second fastening member 92 passed through the second attachment hole 72h of the second metal component 70 is engaged with the attachment hole 42h of the second connection portion 42 of the bus bar 40. By this engagement, the second metal component 70 is fixed to the second connection portion 42 of the bus bar 40. That is, the second assembly SB is fixed to the second connection portion 42 of the bus bar 40. By this fixing, the second electronic component 30 and the second connection portion 42 of the bus bar 40 are electrically connected. In the present embodiment, the direction in which the bus bar 40 is fixed to the base member 11 coincides with the direction in which the second assembly SB is fixed to the bus bar 40.

In the fourth step, the attachment portion 34 of the second electronic component 30 may be fixed to the base member 11 using the fastening member 39. This work is performed as follows, for example. First, the attachment hole 34h of the attachment portion 34 of the second electronic component 30 and the attachment hole 11h of the base member 11 are aligned. Next, the fastening member 39 is inserted into the attachment hole 34h of the second electronic component 30 from the vertical direction. The fastening member 39 passed through the attachment hole 34h of the second electronic component 30 is engaged with the attachment hole 11h of the base member 11. By this engagement, the second electronic component 30 is fixed to the base member 11. The work of fixing the second electronic component 30 to the base member 11 using the fastening member 39 may be performed before or after the work of fixing the second metal component 70 to the bus bar 40 using the second fastening member 92. In the present embodiment, a direction in which the bus bar 40 is fixed to the base member 11, a direction in which the second assembly SB is fixed to the bus bar 40, and a direction in which the second electronic component 30 is fixed to the base member 11 coincide with each other.

### A3. Operation of Invention

Next, an operation of the electrical connection unit 1 in the invention will be described.

When the first electronic component 20 is energized, the body portion 22 of the first electronic component 20 generates heat, and the terminal portion 23 connected to the body portion 22 becomes hot. A part of the heat of the terminal portion 23 is transferred to the metal component 60. The temperature detector 80 is attached to the metal component 60. Therefore, the temperature of the terminal portion 23 can be indirectly detected by the temperature detector 80. The operation of the invention similarly applies to the metal component 70.

### A4. Advantages

In the present embodiment, the electrical connection unit 1 includes the electronic components 20 and 30 having the terminal portions 23 and 33, and the bus bar 40 electrically connected to the terminal portions 23 and 33. The electrical connection unit 1 further includes the metal components 60 and 70 disposed between the terminal portions 23 and 33 and the bus bar 40, and the temperature detector 80 capable of detecting the temperatures of the metal components 60 and 70. The metal components 60 and 70 are in contact with the terminal portions 23 and 33, and are electrically connected to both the terminal portions 23 and 33 and the bus bar 40. The temperature detector 80 is accommodated in the hole portions 60h and 70h provided in the metal components 60 and 70.

According to such a constitution, by accommodating the temperature detector 80 in the hole portions 60h and 70h, the temperature detector 80 can be easily installed on the metal components 60 and 70. For example, it is possible to suppress complication of the work of installing the temperature detector 80 as compared with the case of installing the temperature detector in the first fastening member 81. Therefore, the burden on the operator can be reduced.

### Modification of First Embodiment

In the first embodiment, the case where the temperature detector 80 is attached to the metal components 60 and 70 before the metal components 60 and 70 are attached to the electronic components 20 and 30 or the bus bar 40 has been described. However, the temperature detector 80 may be attached to the metal components 60 and 70 after attaching the metal components 60 and 70 to the electronic components 20 and 30 and the bus bar 40.

In the modification of the first embodiment, in a state where the metal components 60 and 70 are attached to the electronic components 20 and 30 and the bus bar 40, the hole portions 60h and 70h are opened toward the +Z direction. The +Z direction is an example of “upward”. The base member 11 is disposed in the −Z direction of the electronic components 20 and 30 and the bus bar 40.

According to such a constitution, after the metal components 60 and 70 are attached to the electronic components 20 and 30 and the bus bar 40, the temperature detector 80 can be easily accommodated in the hole portions 60h and 70h from the +Z direction. Therefore, the burden on the operator can be reduced.

### Second Embodiment

Next, a second embodiment will be described. The second embodiment is different from the first embodiment in that a metal component includes a component body and a cap. Constitutions other than those to be described below are the same as the constitutions of the first embodiment. In the second embodiment, the Z direction is an example of a “first direction”. The X direction is an example of a “direction intersecting the first direction”.

### B1. Constitution of Metal Component

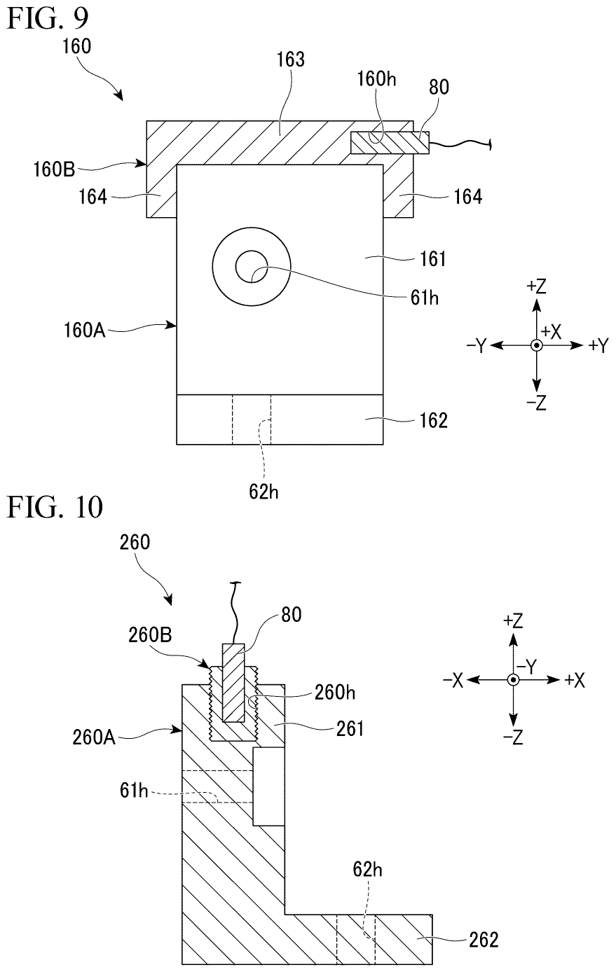

FIG. 9 is a cross-sectional view illustrating a plurality of metal components 160 of the second embodiment. The metal component 160 includes, for example, a metal component body 160A and a cap 160B.

### B1.1 Metal Component Body

The metal component body 160A is a component corresponding to the metal components 60 and 70 of the first embodiment. The metal component body 160A does not have the hole portions 60h and 70h formed in the metal components 60 and 70 of the first embodiment. The metal component body 160A electrically connects the terminal portion 23 of the electronic component 20 and the first connection portion 41 of the bus bar 40. The metal component body 160A electrically connects the terminal portion 33 of the electronic component 30 and the second connection portion 42 of the bus bar 40.

The metal component body 160A has, for example, a first portion 161 and a second portion 162. The details of the first portion 161 and the second portion 162 are similar to those of the first portions 61 and 71 and the second portions 62 and 72. Therefore, in the description regarding the first portion 161 and the second portion 162, “first portion 61” and “first portion 71” may be replaced with “first portion 161”, and “second portion 62” and “second portion 72” may be replaced with “second portion 162”, except for the description regarding the hole portions 60h and 70h related to the metal components 60 and 70 of the first embodiment described above.

### B1.2 Cap

The cap 160B is attached to the metal component body 160A. In the present embodiment, the cap 160B is formed of metal. The cap 160B is attached to the first portion 161 of the metal component body 160A. The cap 160B is attached to the upper end portion of the first portion 161.

The cap 160B includes a cap body 163 and a cap attachment portion 164. The cap body 163 is disposed so as to cover the entire end surface of the first portion 161 facing the +Z direction. A surface of the cap body 163 facing the −Z direction is at least partially in contact with an end surface of the first portion 161. In the present embodiment, the surface of the cap body 163 facing the −Z direction is in contact with the entire end surface of the first portion 161. The cap attachment portion 164 extends in the +X direction from an end portion in the +Y direction and an end portion in the −Y direction of the cap body 163, respectively. These two cap attachment portions 164 sandwich the upper portion of the first portion 161 from the +Y direction and the −Y direction, respectively. The cap 160B formed in this manner is attached to the upper portion of the first portion 161 by being pushed from the +Z direction to the −Z direction. The cap 160B may be fixed to the first portion 161 with an adhesive or the like.

The cap 160B has a hole portion 160h that accommodates the temperature detector 80. In the present embodiment, the hole portion 160h has an opening on a surface of the cap body 163 facing the +Y direction. The hole portion 160h is recessed in the −Y direction from the surface of the cap body 163 facing the +Y direction. In the present embodiment, the hole portion 160h forms a columnar space extending in the Y direction. For example, the temperature detector 80 is inserted into the hole portion 160h and fixed with a thermally conductive adhesive or the like.

### B2. Method of Manufacturing Electrical Connection Unit

Next, a method of manufacturing the electrical connection unit 1 of the second embodiment will be described. Steps other than a first step described below are the same as those in the first embodiment.

### (First Step)

In the first step, the temperature detector 80 is inserted into the hole portion 160h of the cap 160B, and the temperature detector 80 is fixed in the hole portion 160h using a thermally conductive adhesive or the like. By this fixing, the cap 160B of the first metal component 160 and the temperature detector 80 are integrated. In the first step, the cap 160B is attached to the first portion 161. In the second embodiment, after the first step, the second to fourth steps are performed similarly to the first embodiment. The first step may be performed after the fourth step.

### B3. Advantages

In the present embodiment, the metal component 160 includes a metal component body 160A and a cap 160B. The metal component body 160A is in contact with the terminal portions 23 and 33. The cap 160B is attached to the metal component body 160A. The cap 160B has a hole portion 160h that accommodates the temperature detector 80. According to such a constitution, the heat of the terminal portions 23 and 33 is transferred from the first portion 161 of the metal component body 160A to the cap 160B. The temperature detector 80 is accommodated in the hole portion 160h of the cap 160B, and the temperature rise of the cap 160B due to the heat of the terminal portions 23 and 33 transferred to the cap 160B is detected by the temperature detector 80. On the other hand, since it is only necessary to attach the cap 160B to which the temperature detector 80 is attached to the first portion 161 of the metal component body 160A, the temperature detector 80 can be easily attached to the metal component body 160A at desired timing. Therefore, it is possible to reduce the burden on the operator.

### Third Embodiment

Next, a third embodiment will be described. The third embodiment is different from the first embodiment in that a holder is provided. Constitutions other than those to be described below are the same as the constitutions of the first embodiment. In the third embodiment, the Z direction is an example of a “first direction”. The X direction is an example of a “direction intersecting the first direction”.

### C1. Constitution of Metal Component

FIG. 10 is a cross-sectional view illustrating a plurality of metal components 260 of the third embodiment. The metal component 260 includes, for example, a metal component body 260A and a holder 260B.

### C1.1 Metal Component Body

The metal component body 260A is a component corresponding to the metal components 60 and 70 of the first embodiment. The metal component body 260A is different from the metal components 60 and 70 of the first embodiment in that a screw groove is provided on an inner peripheral surface of a hole portion. The metal component body 260A electrically connects the terminal portion 23 of the electronic component 20 and the first connection portion 41 of the bus bar 40. The metal component body 260A electrically connects the terminal portion 33 of the electronic component 30 and the second connection portion 42 of the bus bar 40. The metal component body 260A has, for example, a first portion 261 and a second portion 262. The first portion 261 of the metal component body 260A has a hole portion 260h that can accommodate the temperature detector 80 and the holder 260B. The hole portion 260h is formed in a columnar shape having a screw groove on the inner peripheral surface. The hole portion 260h is formed at the same position as the hole portion 60h of the first embodiment. Details of the first portion 261 and the second portion 262 other than the hole portion 260h are similar to those of the first portions 61 and 71 and the second portions 62 and 72 of the first embodiment.

### C1.2 Holder

The holder 260B holds the temperature detector 80. The holder 260B is made of metal. For example, the holder 260B is formed in a bottomed cylindrical shape. The holder 260B of the present embodiment has a bottomed cylindrical shape with a constant diameter. The holder 260B has a spiral screw thread on the outer peripheral surface. The spiral screw groove formed in the inner peripheral surface of the hole portion 260h corresponds to the screw thread of the holder 260B. That is, the holder 260B can be fastened to the hole portion 260h by a screw operation. The holder 260B can accommodate the temperature detector 80 therein. The temperature detector 80 is fixed to the holder 260B with a thermally conductive adhesive or the like.

### C2. Advantages

In the present embodiment, the metal component 260 includes a holder 260B that holds the temperature detector 80. The holder 260B has a screw thread on the outer peripheral surface. The inner peripheral surface of the hole portion 260h of the metal component 260 has a screw groove corresponding to the screw thread of the holder 260B. According to such a constitution, the heat of the terminal portions 23 and 33 is transferred from the first portion 261 of the metal component body 260A to the holder 260B. The holder 260B accommodates the temperature detector 80, and the temperature detector 80 detects a temperature rise of the holder 260B due to the heat of the terminal portions 23 and 33 transferred to the holder 260B. On the other hand, since the holder 260B can be fixed to the hole portion 260h only by screwing the holder 260B holding the temperature detector 80 into the hole portion 260h, the temperature detector 80 can be easily attached to the metal component body 260A at desired timing. Therefore, it is possible to reduce the burden on the operator.

### Fourth Embodiment

Next, a fourth embodiment will be described. The fourth embodiment is different from the first embodiment in an attachment position of a temperature detector 80 to a metal component. Constitutions other than those to be described below are the same as the constitutions of the first embodiment. In the fourth embodiment, a Z direction is an example of a “first direction”. The X direction is an example of a “direction intersecting the first direction”.

### D1. Constitution of Metal Component

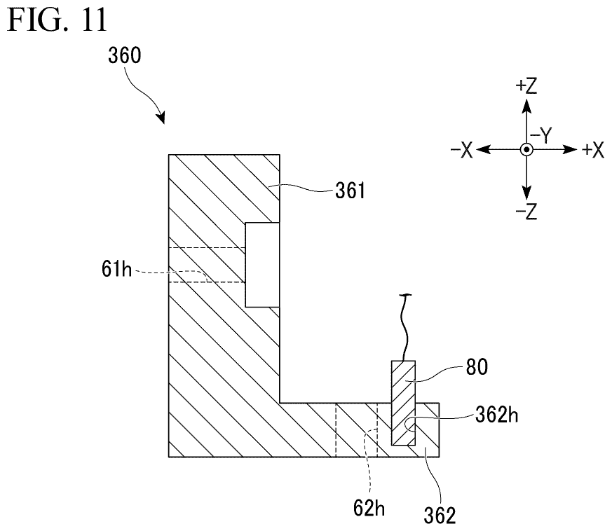

FIG. 11 is a cross-sectional view illustrating a metal component 360 of the fourth embodiment. The metal component 360 is a component corresponding to the metal components 60 and 70 of the first embodiment. The metal component 360 includes, for example, a first portion 361 and a second portion 362. The metal component 360 has an L shape with the first portion 361 and the second portion 362 similarly to the metal component 60 of the first embodiment.

Similarly to the first portions 61 and 71 of the first embodiment, the first portion 361 is a portion connected to the terminal portion 23 of the first electronic component 20. The first portion 361 is different from the first portions 61 and 71 of the first embodiment in that no hole portion is provided, and the other constitutions are the same as those of the first portions 61 and 71 of the first embodiment.

The second portion 362 is a portion connected to the first connection portion 41 of the bus bar 40. The second portion 362 protrudes in the +X direction from an end portion of the first portion 361 on the −Z direction side. The second portion 362 is a plate portion extending in the X direction and the Y direction. The second portion 362 extends in the X direction along the first connection portion 41 of the bus bar 40. In the present embodiment, the second portion 362 has a shape similar to that of the second portion 62 of the first embodiment, and has a second attachment hole 62h through which the second fastening members 82 and 92 (see FIG. 1) pass.

The second portion 362 has a hole portion 362h capable of accommodating the temperature detector 80. The hole portion 362h has an opening on a surface of the second portion 362 facing the +Z direction. The hole portion 362h is recessed in the −Z direction from the surface of the second portion 362 facing the +Z direction. The hole portion 362h has the same shape as the hole portion 60h of the first embodiment, and forms a columnar space extending in the Z direction. The hole portion 362h is formed in a region of the second portion 362 where the second attachment hole 62h is not formed when viewed from the Z direction. The hole portion 362h is formed at a position away in the +X direction from the surface of the first portion 361 facing the +X direction.

### D2. Advantages

A position on the second portion 362 away in the +X direction from the surface of the first portion 361 facing the +X direction tends to be a dead space. In the present embodiment, since the hole portion 362h is provided so as to be opened on the surface of the second portion facing the +Z direction and the temperature detector 80 is attached, a dead space between the first portion 361 and the second portion 362 can be effectively used.

Several embodiments and modifications have been described above. However, the embodiments and the modifications are not limited to the examples described above. For example, two or more embodiments or modifications described above may be implemented in combination with each other. In addition, the embodiments and modifications described above are merely examples. The electrical connection unit 1 is not limited to the constitution including all the dimensional relationships described above, and may have a constitution including only a part of the dimensional relationships described above.

For example, the method of fixing the temperature detector 80 is not limited to using a thermally conductive adhesive. The temperature detector may be fixed by being press-fitted into the hole portion.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### REFERENCE SIGNS LIST

1 Electrical connection unit
10 Housing
11 Base member
11a Support surface
11h Attachment hole
11s Flat surface
12 Cover member
20, 30 Electronic component
21 Case
21a Insulating wall
22 Body portion
23, 33 Terminal portion
23A First terminal portion
23B Second terminal portion
23h, 33h Attachment hole
24, 34 Attachment portion
24A First attachment portion
24B Second attachment portion
24h, 34h Attachment hole
29, 39 Fastening member
31 Case
32 Body portion
40 Bus bar
40s Plate surface
41 First connection portion
41h, 42h, 43h Attachment hole
42 Second connection portion
43 Extension portion
51 Fastening member
52 Engagement member
60, 70, 160, 260, 360 Metal component
60A, 60B Metal component
60h, 70h, 160h, 260h, 362h Hole portion
61, 71, 161, 261, 361 First portion
61h, 71h First attachment hole
62, 72, 162, 262, 362 Second portion
62h, 72h Second attachment hole
80 Temperature detector
81, 91 First fastening member
82, 92 Second fastening member
160A, 260A Metal component body
160B Cap
163 Cap body
164 Cap attachment portion
260B Holder
SA First assembly
SB Second assembly

What is claimed is:

1. An electrical connection unit comprising:
an electronic component having a terminal;
a bus bar electrically connected to the terminal;
a metal component that is disposed between the terminal and the bus bar, is in contact with the terminal, and is electrically connected to both the terminal and the bus bar; and
a temperature detector that is accommodated in a hole portion provided in the metal component and is capable of detecting a temperature of the metal component.

2. The electrical connection unit according to claim 1, wherein
the hole portion provided in the metal component is opened upward.

3. The electrical connection unit according to claim 1, wherein
the metal component includes:
a metal component body in contact with the terminal; and
a cap having the hole portion for accommodating the temperature detector and attached to the metal component body.

4. The electrical connection unit according to claim 1, wherein
the metal component further includes a holder that has a screw thread formed on an outer peripheral surface and holds the temperature detector, and
an inner peripheral surface of the hole portion has a screw groove corresponding to the screw thread of the holder.

5. The electrical connection unit according to claim 1, wherein
the metal component includes a first portion that extends in a first direction and is in contact with the terminal, and a second portion that extends in a direction intersecting with the first portion and is in contact with the bus bar, and
the hole portion is provided in the second portion and is opened on a surface of the second portion facing the first direction.
